(19) United States
(12) Patent Application Publication
(10) Pub. No.: US 2010/0096036 A1
(43) Pub. Date: Apr. 22, 2010

(54) FLUID-CROSSING GATE FOR PIPELINE AND FLUID-CROSSING METHOD USING THE SAME

(76) Inventors: Sang Seek Bae, Daejeon (KR); Seong Seol Cho, Daejeon (KR); Jea Hag Kim, Daejeon (KR); Young Ho Park, Daejeon (KR); Ki Ho Song, Chungcheongnam-do (KR); Myung Sup Song, Chungcheongnam-do (KR)

Correspondence Address: ROSENBERG, KLEIN & LEE, 3458 ELLICOTT CENTER DRIVE-SUITE 101, ELLICOTT CITY, MD, 21043, US

(21) Appl. No.: 12/448,651

(22) PCT Filed: Sep. 11, 2007
(86) PCT No.: PCT/KR2007/004380

§ 371 Date: Dec. 8, 2009

(30) Foreign Application Priority Data
Dec. 29, 2006 (KR) 10-2006-0138029
Apr. 13, 2007 (KR) 10-2007-0036571

(51) Int. Cl. F16L 55/10

(52) U.S. Cl. 138/89; 138/98; 138/94; 138/94.5

(57) ABSTRACT

A fluid-crossing gate for a pipeline which is inserted into the interior of a pipeline through a hole punched at a certain portion of the pipeline for crossing the flow of a fluid, is disclosed, which comprises a cylindrical body which is engaged to the pipeline; an operation shaft which is positioned in the interior of the body and moves up and down; a joint unit which is positioned at a lower side of the operation shaft and is bent at a right angle; and a crossing unit which is engaged to a lower side of the joint unit and is inserted into the interior of a pipeline through a hole as the operation shaft moves down and is mounted in the interior of the pipeline as the joint unit is bent for thereby blocking the flow of a fluid in the interior of the pipeline.

### TECHNICAL FIELD

The present invention relates to a fluid-crossing gate, and in particular to a fluid-crossing gate which is installed at a pipeline through a hole formed at least one point of a pipeline which needs a fluid crossing for thereby more reliably blocking the fluid of a pipeline.

### BACKGROUND ART

A fluid-crossing gate for a pipeline is an apparatus which is mainly used for a repair or supplement for a maintenance of a pipeline in which a certain fluid flows or is mainly used for blocking the flow of a fluid in the interior of a pipeline when doing a work such as an exchange and transfer of a pipeline.

In a conventional art, the flow of a fluid is crossed using a valve installed at a certain point of a fluid pipeline. It is possible to cross the fluid of a fluid at a desired point of a pipeline by using a fluid-crossing gate for thereby minimizing a crossing interval or a crossing time as well as minimizing any customer's inconvenience. Namely, in case that a pipeline is transferred or extended for a new customer of a city gas pipeline or a city water pipeline or in case that an aged pipeline is exchanged or in case that a pipeline is repaired or supplemented for a maintenance, it is needed to previously cross the flow of a fluid. When the supply of a fluid is cut, a lot of customers may have inconveniences. So, it is needed to perform a needed work such as a pipeline transfer or repair while continuously supplying a fluid to a conventional customer.

Such as a fluid-crossing gate is disclosed in the U.S. Pat. No. 4,458,721. The conventional fluid-crossing gate is adapted to a small size pipeline such as a city gas pipeline. A compressed gas or compressed liquid is supplied to a cylindrical expandable flexible sleeve installed at a front end for thereby expanding the same, so that an expanded part closely contacts with an inner wall of the pipeline for thereby crossing the fluid.

However, in the above conventional fluid-crossing gate, when an expandable part is inserted into the pipeline, the inserting work is not easy owing to a lengthy expandable part. In case that the fluid pressure of the pipeline is high, the pressure needed for the expansion of the expandable part should be high, so that the engagement of the expandable part may be loosened. In addition, the expanded expandable part may be broken by means of the water scale in the pipeline. When blocking the fluid, the pipeline may be moved by means of a high pressure of the fluid.

### DISCLOSURE OF INVENTION

### Technical Problem

Accordingly, it is an object of the present invention to provide a fluid-crossing gate for a pipeline and a fluid-crossing method using the same, in which the fluid-crossing gate is inputted into the interior of a pipeline through a hole formed at a certain point of a pipeline for thereby more reliably blocking the flow of a fluid.

### Technical Solution

To achieve the above object, there is provided a fluid-crossing gate for a pipeline which is inserted into the interior of a pipeline through a hole punched at a certain portion of the pipeline for crossing the flow of a fluid which comprises a cylindrical body which is engaged to the pipeline; an operation shaft which is positioned in the interior of the body and moves up and down; a joint unit which is positioned at a lower side of the operation shaft and is bent at a right angle; and a crossing unit which is engaged to a lower side of the joint unit and is inserted into the interior of a pipeline through a hole as the operation shaft moves down and is mounted in the interior of the pipeline as the joint unit is bent for thereby blocking the flow of a fluid in the interior of the pipeline.

The crossing unit includes a pair of exploding plates which are exploded in a radial shape by means of a pressure of the operation fluid and closely contact with an inner surface of the pipeline.

The crossing unit includes a cylinder which is engaged to a lower side of the joint unit; a piston which is inserted into the interior of the cylinder; a cap which is engaged to a lower side of the piston and has a groove at a side surface of the same; a head body which is engaged to a lower side of the cylinder; a head cover which is engaged to a lower side of the head body in a shape corresponding to the head body; a plurality of levers of which the outer ends are rotatably engaged between the head body and the head cover, and the inner ends are inserted into the groove of the cam; and an exploding plate which is engaged to each lever, whereby when the piston moves down in the interior of the cylinder with the help of the pressure of the operation fluid, the cam and the inner end of the lever move down, and the exploding plate is exploded and closely contacts with an inner surface of the pipeline.

The crossing unit further includes a packing engaged to the exploding plate.

There is further provided an operation fluid pipe which passes through the joint unit through the interior of the body and is connected with the cylinder for thereby supplying the operation fluid to the interior of the cylinder.

The joint unit includes an upper joint having a slant surface at a lower side of the same, and a lower joint which is engaged with the upper joint through an engaging shaft, whereby the lower joint moves and is bent from a lower side of the upper joint to a side portion along the slant surface.

The engaging shaft is inclined in a bent direction while slightly deviating from an extension line of the operation shaft.

There is further provided a roller which is installed at a lower side of the crossing unit and slides while contacting with an inner surface of the pipeline when the crossing unit is inserted into the interior of the pipeline.

The roller includes a first roller and a second roller, and the first roller is positioned in a direction that the joint unit is bent, and is protruded more than the second roller.

There is further provided a driving force unit for generating a driving force, and a rotary shaft which rotates by means of the driving force from the driving force unit, and the operation shaft moves up and down based on a rotation of the rotary shaft.

There is further provided an engaging member which is installed at two points of the pipeline and has at least one engaging part, and a safety post which is inserted between the opposite engaging parts and has a support rod which has an adjustable length.

To achieve the above objects, there is provided a fluid-crossing gate for a pipeline which is inserted into the interior of a pipeline through a hole punched at a certain portion of the pipeline for crossing the flow of a fluid which comprises a cylindrical body which is engaged to the pipeline; a driving force unit which generates a driving force; a rotary shaft which is positioned in the interior of the body and rotates by means of a driving force of the driving force unit; an operation shaft which is positioned in the interior of the body and moves up and down based on a rotation of the rotary shaft; a joint unit which is positioned at a lower side of the operation shaft and is bent at a right angle; a crossing unit which includes a cylinder which is engaged to a lower side of the joint unit; a piston which is inserted into the interior of the cylinder; a cap which is engaged to a lower side of the piston and has a groove at a side surface of the same; a head body which is engaged to a lower side of the cylinder; a head cover which is engaged to a lower side of the head body in a shape corresponding to the head body; a plurality of levers of which the outer ends are rotatably engaged between the head body and the head cover, and the inner ends are inserted into the groove of the cam; and an exploding plate which is engaged to each lever; and an operation fluid pipe which passes through the joint unit through the interior of the body and is connected with the cylinder for thereby supplying the operation fluid to the interior of the cylinder, whereby the crossing unit is inserted into the interior of the pipeline through the hole as the operation shaft moves down and is mounted in the interior of the pipeline as the joint unit is bent, and when the operation fluid is supplied to the interior of the cylinder through the operation fluid pipe, the piston moves down in the interior of the cylinder, and the cam and the inner end of the lever move down, and the exploding plate is exploded and closely contacts with an inner surface of the pipeline for thereby blocking the flow of the fluid in the interior of the pipeline.

To achieve the above objects, there is provided a fluid-crossing method using a fluid-crossing gate for a pipeline which comprises a step in which a valve assembly is installed at two points of a pipeline, and a hole is respectively formed using a punching machine; a step in which a fluid-crossing gate is installed at the valve assembly; a step in which the operation shaft of the fluid-crossing gate is moved down, and the crossing unit of the fluid-crossing gate is inserted into the interior of the pipeline; a step in which the operation shaft is further moved down, and the crossing unit is mounted in the interior of the pipeline as the joint unit of the fluid-crossing gate is bent at a right angle; a step in which the operation fluid is supplied to the crossing unit, and the crossing unit blocks the flow of the fluid in the interior of the pipeline; a step in which one work among a pipeline change, transfer, repair and supplement work is performed in a state that the flow of the fluid is disconnected by the crossing unit; and a step in which the fluid-crossing gate and the valve assembly are removed, and the hole punched on the pipeline is sealed.

There is further provided a step in which a safety post is installed near two points of the pipeline in which the fluid-crossing gate is installed.

### Advantageous Effects

The fluid-crossing gate for a pipeline according to the present invention may be used when blocking the flow of the fluid when changing, transferring or repairing the pipeline in which fluid flows like a city gas pipeline or a city water pipeline. In particular, the fluid-crossing gate for a pipeline according to the present invention is able to minimize the disconnection section and time for thereby decreasing the customer's inconvenience while continuously supplying the fluid to the customers in such a manner that the flow of the fluid is disconnected at a desired point of the pipeline.

### BRIEF DESCRIPTION OF THE DRAWINGS

The present invention will become better understood with reference to the accompanying drawings which are given only by way of illustration and thus are not limitative of the present invention, wherein;

FIG. 1 is a cross sectional view illustrating a state that a fluid-crossing gate is installed at a pipeline according to the present invention;

FIG. 2 is a cross sectional view illustrating a fluid-crossing gate according to the present invention;

FIG. 3 is a detailed view illustrating a joint unit of a fluid-crossing gate according to the present invention;

FIG. 4 is a detailed view illustrating a crossing unit of a fluid-crossing gate according to the present invention;

FIG. 5 is a lateral cross sectional view when viewing the construction of FIG. 2 in another direction according to the present invention;

FIGS. 6 and 7 are cross sectional and bottom views illustrating a head body of a fluid-crossing gate according to the present invention;

FIGS. 8 and 9 are cross sectional and plane views of a head cover of a fluid-crossing gate according to the present invention;

FIG. 10 is a perspective view illustrating a lever and exploding plate of a fluid-crossing gate according to the present invention;

FIGS. 11 and 12 are bottom and side views illustrating a state that an exploding plate and a packing of a fluid-crossing gate are unexploded according to the present invention;

FIGS. 13 and 14 are bottom and side views illustrating a state that an exploding plate and a packing of a fluid-crossing gate are exploded according to the present invention;

FIGS. 15 through 17 are cross sectional views illustrating a state that a safety post of a fluid-crossing gate is installed at a pipeline according to the present invention; and

FIG. 19 is a disassembled perspective view illustrating a safety post of FIG. 18.

### BEST MODE FOR CARRYING OUT THE INVENTION

In the present invention, a fluid-crossing gate for a pipeline which is inserted into the interior of a pipeline through a hole punched at a certain portion of the pipeline for crossing the flow of a fluid comprises a cylindrical body which is engaged to the pipeline; an operation shaft which is positioned in the interior of the body and moves up and down; a joint unit which is positioned at a lower side of the operation shaft and is bent at a right angle; and a crossing unit which is engaged to a lower side of the joint unit and is inserted into the interior of a pipeline through a hole as the operation shaft moves down and is mounted in the interior of the pipeline as the joint unit is bent for thereby blocking the flow of a fluid in the interior of the pipeline.

### Mode for the Invention

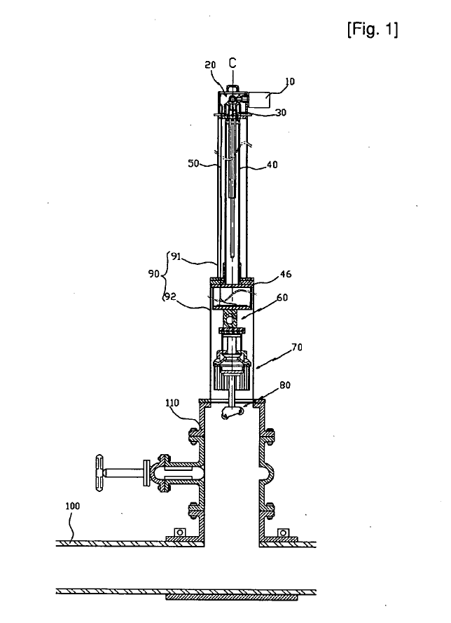

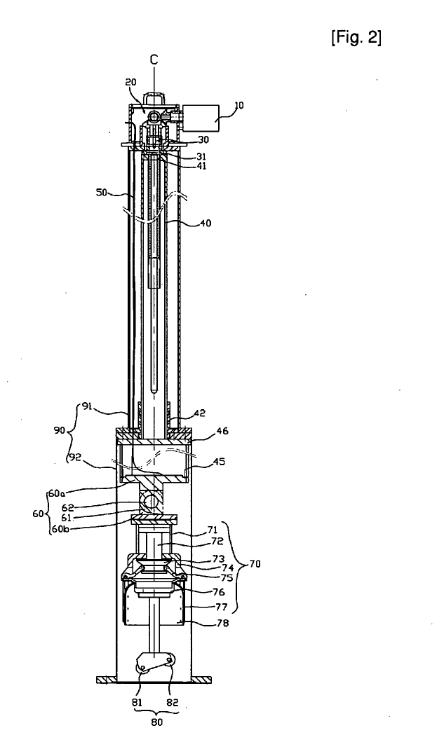

As shown in FIGS. 1 and 2, a valve assembly 110 is installed at a certain portion of a pipeline 100, and a hole is formed using a punching machine. For a fluid crossing work, it is needed to disconnect the flow of a fluid at both ends of a pipeline 100 which needs an exchange, transfer, repair or supplement of the same. The fluid-crossing gate of the present invention is inputted into the interior of each pipeline 100 through a hole formed at two points of the pipeline 100 for thereby disconnecting the flow of a fluid. Here, the number of the holes is not limited. The holes may be formed at multiple points.

The fluid-crossing gate comprises a cylindrical body 100, and the body 100 includes an upper body 91 and a lower body 92. The upper and lower bodies 91 and 92 are engaged by means of a certain method such as a flange method. The lower body 92 is engaged to the valve assembly 110 installed in the pipeline 100 by means of the flange method.

A driving force unit 10 is installed at an upper side of the upper body 91 for generating a driving force. There is provided a driving force transfer unit 20 for transferring the driving force of the driving force unit 10. Here, the driving force unit 10 is for example an electric motor, and the driving force transfer unit 20 is for example a bevel gear which is able to transfer the driving force while changing its transfer direction. When the shaft of the driving force unit 10 is matched with the center axis C of the fluid-crossing gate, the driving force transfer unit 20 may not be needed.

In the interior of the upper body 91, a rotary shaft 30 is connected with a lower end of the driving force transfer unit 20, and an operation shaft 40 is connected with a lower end of the rotary shaft 30. The operation shaft 40 moves up and down with the help of the rotation of the rotary shaft 30. As one example, it is possible to change the rotational movement of the rotary shaft 30 into the up and down movements of the operation shaft 40 by forming a male thread 31 at the rotary shaft 30 and a female thread 41 at the operation shaft 40 for thereby forming a cam structure.

A guide housing 42 into which the operation shaft 40 is inserted is installed at an inner lower end of the upper body 91. The guide housing 42 is provided for decreasing any movements when the operation shaft 40 moves up and down.

A connection shaft 45 is installed at an inner upper end of the lower body 92. The connection shaft 45 is connected with a lower end of the operation shaft 40 and moves up and down in the lower body 92. The operation shaft 40 and the connection shaft 45 may be integral. An end portion 46 having an outer diameter similar with an inner diameter of the lower body 92 is formed at an upper end of the connection shaft 45. Here, the end portion 46 is provided for preventing any movements when the connection shaft 45 moves up and down and any movements of the operation shaft 40.

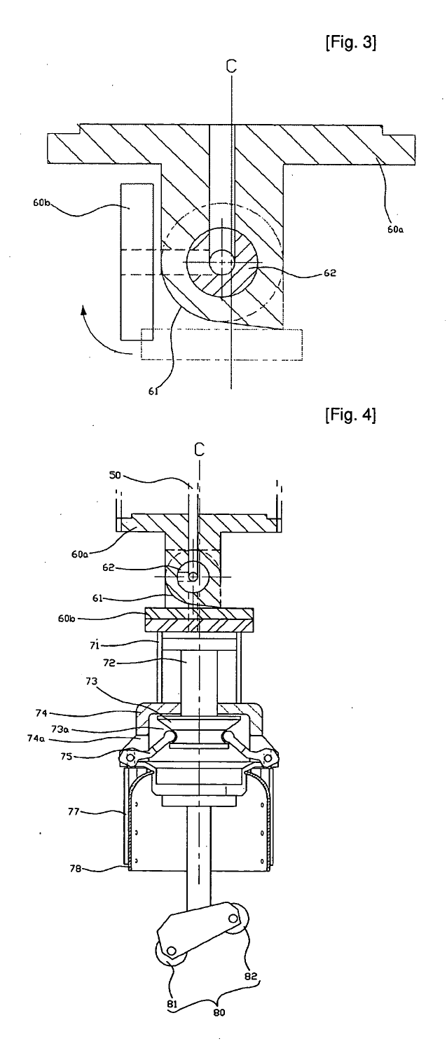

A joint unit 60 is engaged at a lower end of the connection shaft 45 in the interior of the lower body 92. The joint unit 60 is formed of an upper joint 60a and a lower joint 60b. A slant surface 61 is formed at a lower side of the upper joint 60a. As shown in FIG. 3 which shows the joint unit 60 in details, the lower joint 60a is engaged with the upper joint 60a through an engaging shaft 62 and is movable along the slant surface 61 of the upper joint 60a while being bent from the lower side of the upper joint 60a to the side direction or vice versa. Namely, the joint unit 60 can be bent at a right angle. It is preferred that the engaging shaft 62 slightly stays away from the center axis C for smooth movements. When the engaging shaft 62 slightly stays away from the center axis C corresponding to an extended line of the operation shaft 40, the joint unit 60 can be more reliably bent with the help of the self-weight of the crossing unit 70.

As shown in FIGS. 1 and 2, the operation fluid supply pipe 50 passes through the connection shaft 45 and the joint unit 60 through the interior of the body 90 and is connected with the cylinder of the crossing unit 70. A through hole(not shown) is formed at the connection shaft 45 and the joint unit 60 for allowing the operation fluid supply pipe 50 to pass. The through hole formed at the joint unit 60 is formed so that the bending operation of the joint unit 60 is not interfered. So, the through holes formed at the upper and lower joints 60a and 60b of the joint unit 60 communicate with the through hole formed at the engaging shaft 62.

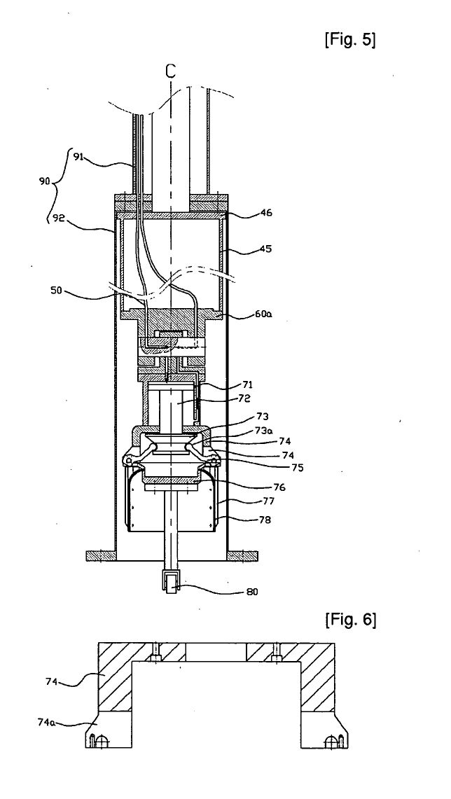

The crossing unit 70 is engaged at the lower joint 60b of the joint unit 60. As shown in FIGS. 4 and 5, the crossing unit 70 includes a cylinder 71, a piston 72, a cam 73, a head body 74, a lever 75, a head cover 76, an exploding plate 77 and a packing 78.

The cylinder 71 is engaged with the lower joint 60b of the joint unit 60 with the operation fluid supply pipe 50 being connected with the interior of the cylinder 71. The piston 72 reciprocates in the interior of the cylinder 71 based on the pressure of the operation fluid supplied through the operation fluid supply pipe 50. Here, the operation fluid may be selected from a gas or a liquid.

A cam 73 is engaged at a lower side of the piston 72, and the head body 74 is engaged at a lower side of the cylinder 71. A head cover 76 having a certain shape corresponding to the head body 74 is engaged at a lower side of the head body 74. A plurality of levers 75 are rotatably engaged between the head body 74 and the head cover 76. The lever 75 is inserted into a groove 73a formed at a side surface of the cam 73. The lever 75 is engaged with the exploding plate 77, and the head cover 76 is engaged with the packing 78. The exploding plate 77 and the packing 78 are engaged with each other.

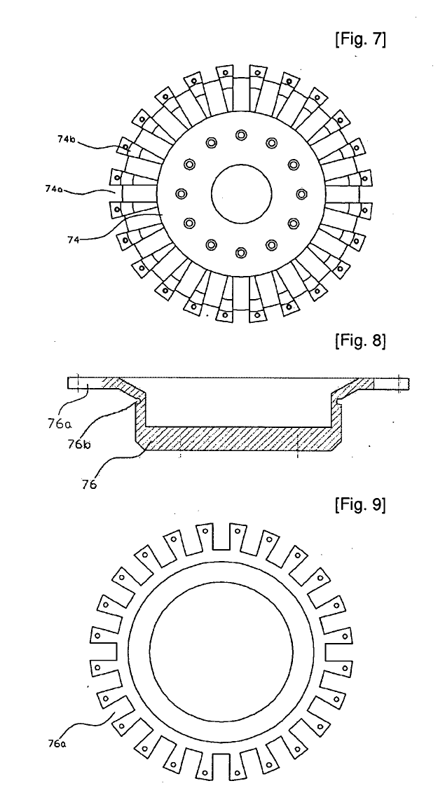

As shown in FIG. 6, the head body 74 is protruded in a downward direction along a circular edge, and as shown in FIG. 7, a plurality of lever support shoulders 74a are formed along the circular edge at regular intervals. As shown in FIG. 8, the head cover 76 is protruded in an upward direction along a circular edge, and as shown in FIG. 9, the lever support shoulders 76 are formed along the circular edge at regular intervals. The groove 74b is formed at the lever support shoulder 74a of the head body 74. A groove may be formed at the lever support shoulder 76a of the head cover 76.

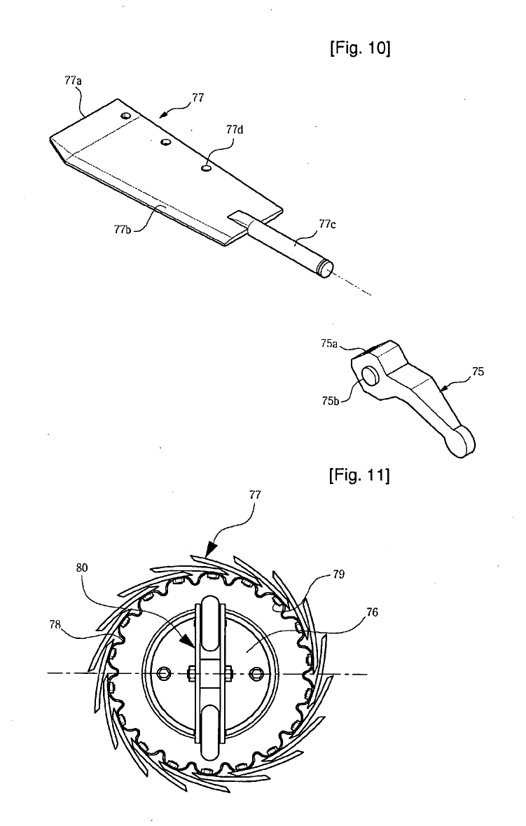

As shown in FIG. 10, the lever 75 is positioned between the head body 74 and the head cover 76. Namely, it is provided in each space between the neighboring lever support shoulders 74a and 76a. The levers 75 are arranged in a radial shape. A short shaft 75b is formed at an outer end of each lever 75 and are supported in the grooves 7 4b of the lever support shoulders 74a of the head body 74. Each lever 74 disposed between the lever support shoulders 74a and 76b is fixedly inserted between the head body 74 and the head cover 76 through the short shaft 75b, but is positioned in the space between the lever support shoulders 74a and 76a, so that it can rotate with respect to the short shaft 75b. The inner end of the lever 75 is inserted into the groove 73a formed at a side surface of the cam 73.

A hole 75a is formed at an outer surface of the lever 75. As shown in FIG. 10, the shaft 77c of the exploding plate 77 is inserted into the hole 75a. Here, the exploding plate 77 is formed of an outer slant surface 77a and a side slant surface 77b. In a state that the exploding plate 77 is exploded, the outer slant surface 77a closely contracts with an inner surface of the pipeline 100, and the side slant surface 77b of the neighboring exploding plate 77 closely contacts with the side slant surface 77b. Namely, when the exploding plate 77 is fully exploded, it blocks the interior of the pipeline 100 for thereby crossing the flow of the fluid.

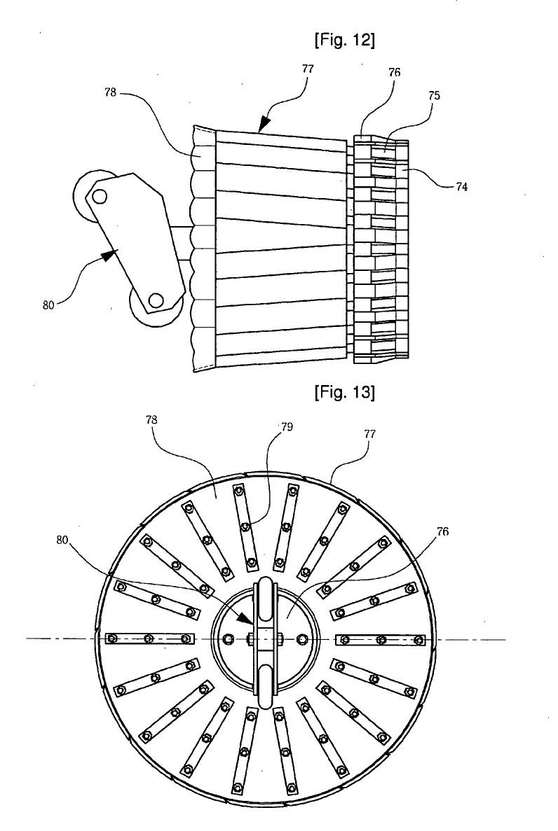

A circular packing 78 is preferably engaged with the exploding plate 77 for enhancing a crossing effect of the flow of a fluid. The packing 78 is engaged in the groove (76b of FIG. 8) formed at a side surface of the head cover 76, and as shown in FIGS. 11 and 13, it is engaged with the exploding plate 77 with a screw 79. As shown in FIG. 10, an engaging hole 77d is formed at the exploding plate 77 for an engagement with a screw.

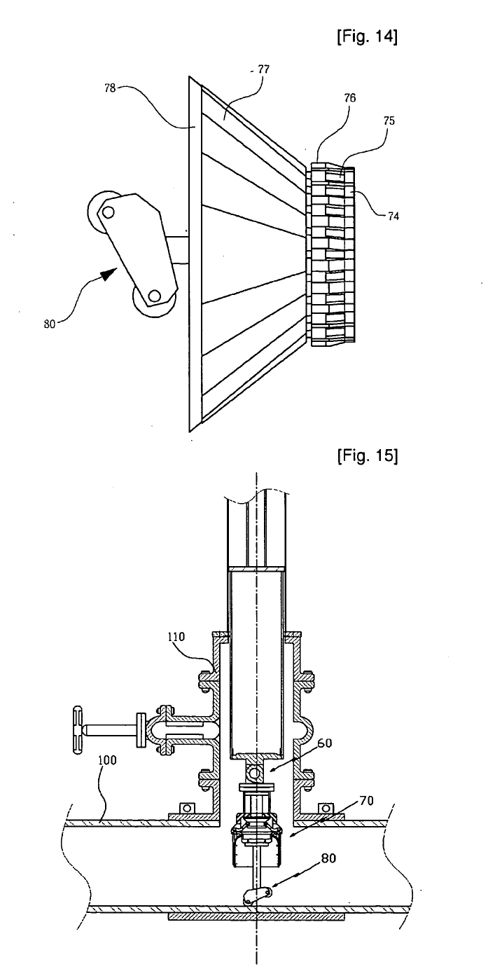

Being engaged with the exploding plate 77, the packing 78 is also exploded or unexploded as the exploding plate 77 is exploded or unexploded. FIGS. 11 and 12 shows a state that the exploding plate 77 and the packing 78 are unexploded, and FIGS. 13 and 14 show a state that the exploding plate 77 and the packing 78 are exploded. Here, the packing 78 is preferably made of a certain elastic material such as a rubber or a synthetic resin. As shown in FIGS. 12 and 14, it is preferably longer than the exploding plate 77. So, in a state that the exploding plate 77 is exploded, when it closely contacts with the inner surface of the pipeline 100, it is possible to prevent a certain gap from being formed between the inner surfaces of the exploding plate 77 and the pipeline 100.

The operation of the crossing unit 70 for crossing the flow of a fluid in the interior of the pipeline 100 will be described. The crossing work of the flow of the fluid is performed by means of the exploding plate 77 and the packing 78. Here, the exploding plate 77 and the packing 78 are exploded or unexploded by means of the cam 73 engaged at a lower side of the piston 72. The piston 72 operates based on a pressure change of the operation fluid supplied in the interior of the cylinder 71 through the operation fluid supply pipe 50.

In more detail, as the operation fluid is supplied into the interior of the cylinder 71 through the operation fluid supply pipe 50, the piston 72 moves down by means of the pressure of the fluid. When the piston 72 moves down, the cam 73 engaged to the piston 72 moves down as well, and the inner end of the lever 75 inserted into the groove 73a of the side surface of the cam 73 moves down. So, the lever 75 of which an outer end is rotatably engaged between the head body 74 and the head cover 76 rotates from a slant state to a nearly horizontal state, and the exploding plate 77 engaged to the lever 75 is exploded outwardly. So, the exploded exploding plate 77 closely contacts with the inner surface of the pipeline 100 and fully blocks the interior of the pipeline 100 for thereby crossing the flow of the fluid. In a case that the packing 78 is engaged at the exploding plate 77, the packing 78 is also exploded along with the operation of the exploding plate 77.

A roller 89 is installed at a lower center portion of the head cover 76 and is protruded more than the exploding plate 77. The crossing unit 70 is bent in the direction of the pipeline 100 in the interior of the same with the help of the joint unit 60. Here, the roller 80 is adapted for helping the bending work of the joint unit 60. When the crossing unit 70 is inserted into the interior of the pipeline 100, the roller 80 slides while contacting with the inner surface of the pipeline 100. For a more reliable sliding operation, the roller 80 is formed of a first roller 81 and a second roller 82. The first roller 81 is installed in the bending direction of the joint unit 60, and the second roller 82 is installed in the opposite direction. The first roller 81 is protruded more than the second roller 82 so that it first contacts with an inner surface of the pipeline 100 rather than the second roller 82.

The operation of the fluid-crossing gate and the fluid crossing method using the same according to the present invention will be described with reference to FIGS. 15 through 17.

As shown in FIG. 15, the valve assembly 110 is installed at two points of the pipeline 100, and the holes are formed using a punching machine. The above operation is a known art, so that the description of the same will be omitted.

The fluid-crossing gate according to the present invention is installed at the valve assembly 110 installed in the pipeline 100. Here, the fluid-crossing gate is engaged with the valve assembly 110 through the lower body 92 by means of the flange method.

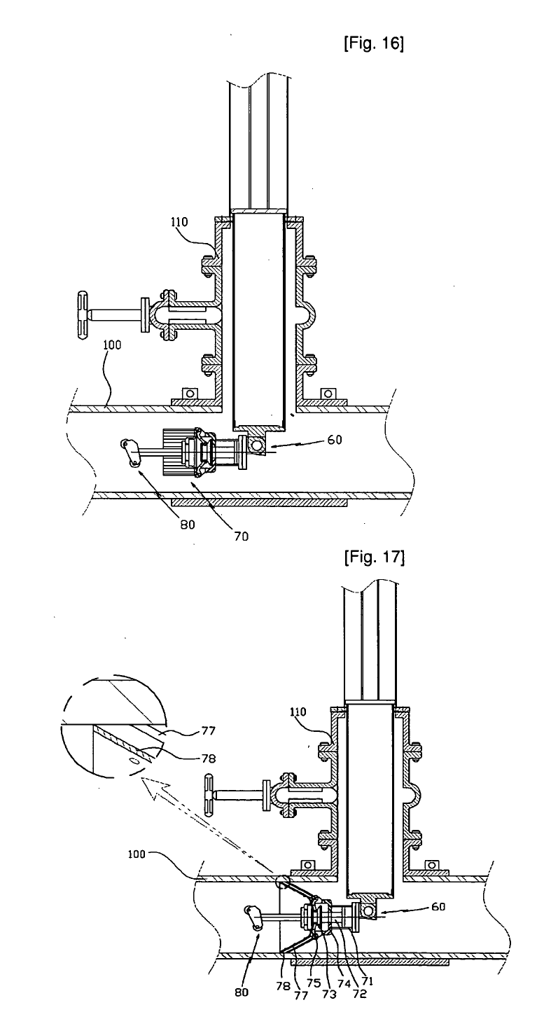

The fluid-crossing gate gets operated, and the crossing unit 70 of the fluid-crossing gate is inputted into the interior of the pipeline 100. In more detail, the driving force unit 10 generates a driving force, and the generated driving force is transferred through the driving force transfer unit 20 for thereby rotating the rotary shaft 30. The operation shaft 40 moves down as the rotary shaft 30 rotates, and as the operation shaft 40 moves down, the crossing unit 70 is inputted into the interior of the pipeline 100 through the hole formed in the pipeline 100. When the operation shaft 40 keeps moving down, the roller 80 contacts with the inner surface of the pipeline 100. When the operation shaft 40 moves down more, the roller 80 slides along the inner surface of the pipeline 100, so that the joint unit 60 is bent at a right angle. So, the crossing unit 70 is horizontally mounted in the interior of the pipeline 100. The above operation is shown in FIG. 16.

The operation fluid is supplied, and the crossing unit 70 gets started for thereby crossing the flow of the fluid in the interior of the pipeline 100. This operation is show in FIG. 17. In more detail, the operation fluid is supplied into the interior of the cylinder 71 through the operation fluid supply pipe 50. The piston 72 and the cam 73 move forward with the help of the pressure of the operation fluid, and the lever 75 installed between the cam 73 and the head body 74 is operated. As the lever 75 operates, the exploding plate 77 installed in the lever 75 is exploded in a radial shape and closely contacts with the inner surface of the pipeline 100. So, the interior of the pipeline 100 is fully blocked by means of the exploding plate 77, and the flow of the fluid is crossed. In case that the packing 78 is engaged at the exploding plate 77, the packing 78 is exploded along with the exploding plate 77.

When the flow of the fluid is crossed in the interior of the pipeline 100 by means of the crossing unit 70, a pipeline exchange work or a maintenance work is performed, and after the work is finished, the fluid-crossing gate for a pipeline and the valve assembly are removed, and the punched holes are sealed.

As described above, since the engaging shaft 62 of the joint unit 60 is deviated from the center axis C of the fluid-crossing gate, the joint unit 60 is bent by means of the self-weight of the crossing unit 70, so that the crossing unit 70 inserted into the pipeline 100 can be easily horizontally moved into the pipeline 100. The insertion into the pipeline 100 of the crossing unit 70 is more efficiently performed with the help of the sliding operation of the roller 80 installed at the front end of the crossing unit 70.

In the present invention, since the exploding plate 77, which is exploded in the radial direction, is closely contacted in the interior of the pipeline 100 for thereby blocking the flow of the fluid, no problems occur even when the pressure of the fluid is high. In addition, a high pressure fluid can be effectively blocked since the packing 78 engaged to the exploding plate 77 helps the blocking of the fluid.

In the present invention, a safety post may be provided for preventing the pipeline 100 from being deviated due to an impact which may occur during the crossing work of the fluid using the fluid-crossing gate, and for preventing a safety accident.

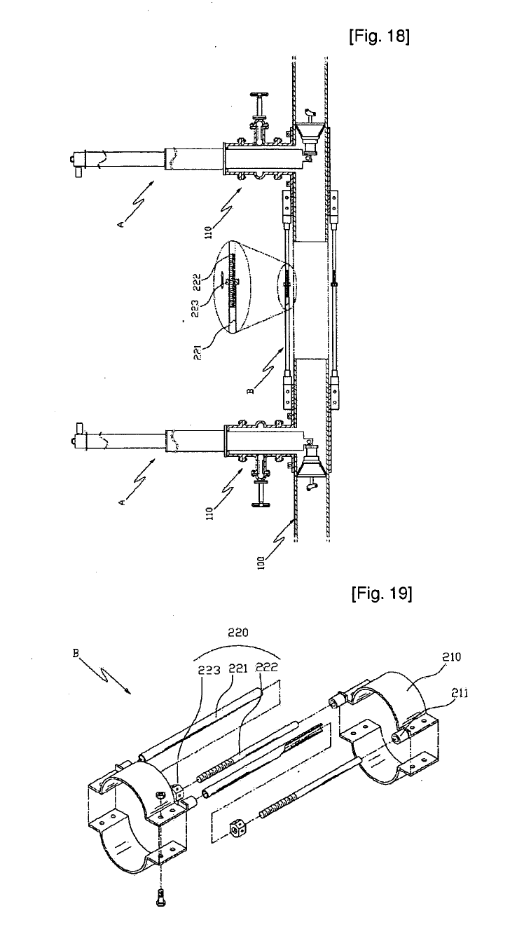

As shown in FIGS. 18 and 19, the safety post B is installed between the fluid-crossing gates A which are installed at two points of the pipeline 100 and is formed of an engaging member 210 and a support rod 220.

The engaging member 210 is formed of a pair of semicircular bands, and each pair of the same are installed at two points of the pipeline 100 in which the fluid-crossing gate A is installed. Here, the engaging member 210 is installed using a bolt and a nut. At least one or two engaging parts 211 are provided in the engaging member 210. A support rod 220 is inserted into each engaging part 211. The support rod 220 is inserted between the opposite engaging ports 211.

The support rod 220 is formed of a hollow pipe 221, a thread rod 222, and an adjusting part 223. The thread rod 222 is thread-engaged into the hollow pipe 221. The length of the same is adjusted using the adjusting part 223 inserted into the thread rod 222.

### INDUSTRIAL APPLICABILITY

The fluid-crossing gate for a pipeline according to the present invention may be used when blocking the flow of the fluid when changing, transferring or repairing the pipeline in which fluid flows like a city gas pipeline or a city water pipeline. In particular, the fluid-crossing gate for a pipeline according to the present invention is able to minimize the disconnection section and time for thereby decreasing the customer's inconvenience while continuously supplying the fluid to the customers in such a manner that the flow of the fluid is disconnected at a desired point of the pipeline.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A fluid-crossing gate for a pipeline which is inserted into the interior of a pipeline through a hole punched at a certain portion of the pipeline for crossing the flow of a fluid, comprising:
a cylindrical body which is engaged to the pipeline;
an operation shaft which is positioned in the interior of the body and moves up and down;
a joint unit which is positioned at a lower side of the operation shaft and is bent at a right angle; and
a crossing unit which is engaged to a lower side of the joint unit and is inserted into the interior of a pipeline through a hole as the operation shaft moves down and is mounted in the interior of the pipeline as the joint unit is bent for thereby blocking the flow of a fluid in the interior of the pipeline.

2. The gate of claim 1, wherein said crossing unit includes a pair of exploding plates which are exploded in a radial shape by means of a pressure of the operation fluid and closely contact with an inner surface of the pipeline.

3. The gate of claim 1, wherein said crossing unit includes:
a cylinder which is engaged to a lower side of the joint unit;
a piston which is inserted into the interior of the cylinder;
a cap which is engaged to a lower side of the piston and has a groove at a side surface of the same;
a head body which is engaged to a lower side of the cylinder;
a head cover which is engaged to a lower side of the head body in a shape corresponding to the head body;
a plurality of levers of which the outer ends are rotatably engaged between the head body and the head cover, and the inner ends are inserted into the groove of the cam; and
an exploding plate which is engaged to each lever,
whereby when the piston moves down in the interior of the cylinder with the help of the pressure of the operation fluid, the cam and the inner end of the lever move down, and the exploding plate is exploded and closely contacts with an inner surface of the pipeline.

4. The gate of either claim 2 or claim 3, wherein said crossing unit further includes a packing engaged to the exploding plate.

5. The gate of claim 3, further comprising:
an operation fluid pipe which passes through the joint unit through the interior of the body and is connected with the cylinder for thereby supplying the operation
fluid to the interior of the cylinder.

6. The gate of claim 1, wherein said joint unit includes an upper joint having a slant surface at a lower side of the same, and a lower joint which is engaged with the upper joint through an engaging shaft, whereby the lower joint moves and is bent from a lower side of the upper joint to a side portion along the slant surface.

7. The gate of claim 6, wherein said engaging shaft is inclined in a bent direction while slightly deviating from an extension line of the operation shaft.

8. The gate of claim 1, further comprising:
a roller which is installed at a lower side of the crossing unit and slides while contacting with an inner surface of the pipeline when the crossing unit is inserted into the interior of the pipeline.

9. The gate of claim 8, wherein said roller includes a first roller and a second roller, and said first roller is positioned in a direction that the joint unit is bent, and is protruded more than the second roller.

10. The gate of claim 1, further comprising a driving force unit for generating a driving force, and a rotary shaft which rotates by means of the driving force from the driving force unit, and said operation shaft moves up and down based on a rotation of the rotary shaft.

11. The gate of claim 1, further comprising an engaging member which is installed at two points of the pipeline and has at least one engaging part, and a safety post which is inserted between the opposite engaging parts and has a support rod which has an adjustable length.

12. A fluid-crossing gate for a pipeline which is inserted into the interior of a pipeline through a hole punched at a certain portion of the pipeline for crossing the flow of a fluid, comprising:
a cylindrical body which is engaged to the pipeline;
a driving force unit which generates a driving force;
a rotary shaft which is positioned in the interior of the body and rotates by means of a driving force of the driving force unit;
an operation shaft which is positioned in the interior of the body and moves up and down based on a rotation of the rotary shaft;
a joint unit which is positioned at a lower side of the operation shaft and is bent at a right angle;
a crossing unit which includes a cylinder which is engaged to a lower side of the joint unit; a piston which is inserted into the interior of the cylinder; a cap which is engaged to a lower side of the piston and has a groove at a side surface of the same; a head body which is engaged to a lower side of the cylinder; a head cover which is engaged to a lower side of the head body in a shape corresponding to the head body; a plurality of levers of which the outer ends are rotatably engaged between the head body and the head cover, and the inner ends are inserted into the groove of the cam; and an exploding plate which is engaged to each lever; and
an operation fluid pipe which passes through the joint unit through the interior of the body and is connected with the cylinder for thereby supplying the operation fluid to the interior of the cylinder, whereby the crossing unit is inserted into the interior of the pipeline through the hole as the operation shaft moves down and is mounted in the interior of the pipeline as the joint unit is bent, and when the operation fluid is supplied to the interior of the cylinder through the operation fluid pipe, the piston moves down in the interior of the cylinder, and the cam and the inner end of the lever move down, and the exploding plate is exploded and closely contacts with an inner surface of the pipeline for thereby blocking the flow of the fluid in the interior of the pipeline.

13. A fluid-crossing method using a fluid-crossing gate for a pipeline, comprising:
a step in which a valve assembly is installed at two points of a pipeline, and a hole is respectively formed using a punching machine;
a step in which a fluid-crossing gate is installed at the valve assembly;
a step in which the operation shaft of the fluid-crossing gate is moved down, and the crossing unit of the fluid-crossing gate is inserted into the interior of the pipeline;
a step in which the operation shaft is further moved down, and the crossing unit is mounted in the interior of the pipeline as the joint unit of the fluid-crossing gate is bent at a right angle;
a step in which the operation fluid is supplied to the crossing unit, and the crossing unit blocks the flow of the fluid in the interior of the pipeline;
a step in which one work among a pipeline change, transfer, repair and supplement work is performed in a state that the flow of the fluid is disconnected by the crossing unit; and
a step in which the fluid-crossing gate and the valve assembly are removed, and the hole punched on the pipeline is sealed.

14. The gate of claim 13, further comprising a step in which a safety post is installed near two points of the pipeline in which the fluid-crossing gate is installed.
